(19) United States
(12) Patent Application Publication
(10) Pub. No.: US 2019/0262876 A1
(43) Pub. Date: Aug. 29, 2019

(54) CLEANING DISINFECTION AND DRYING SYSTEM

(71) Applicants: Patrick WERNER, Mühldorf am Inn (DE); Belimed Life Science AG, Sulgen (CH)

(72) Inventor: Patrick Werner, Mühldorf am Inn (DE)

(21) Appl. No.: 16/342,602

(22) PCT Filed: Oct. 19, 2017
(86) PCT No.: PCT/EP2017/001229

§ 371 Date: Apr. 17, 2019

(30) Foreign Application Priority Data
Oct. 19, 2016 (DE) 102016012488.1

(51) Int. Cl. B08B 15/02; B08B 3/00; B08B 3/14

(52) U.S. Cl. CPC B08B 15/026; B08B 3/14; B08B 3/006

(57) ABSTRACT

A cleaning, disinfection and drying system for preparing at least one of accessory parts and/or items for washing in general, in particular in pharmaceutical production and medical technology, includes a washing chamber including an access door and in which supply devices for washing liquids and drying air are arranged on spray nozzles and washing arms with spray nozzles, wherein the washing chamber includes an isolator system and has carriers for items for washing, incoming air and outgoing air guide devices provided with filters, a glove carrier, which is arranged in a wall of the washing chamber, for gloves extending into the washing chamber configured to manipulate the item for washing located in the washing chamber, and wherein the incoming air and outgoing air guide devices are configured to maintaining a differential pressure between the washing chamber and a work area in which the system is arranged.

### BACKGROUND OF THE INVENTION

The invention relates to a cleaning, disinfection and drying system for preparing accessory parts and/or items for washing in general, in particular in pharmaceutical production and medical technology, comprising a washing compartment which is provided with an access door and in or on which supply devices for washing liquids and drying air are arranged on spray nozzles and washing arms with spray nozzles.

The invention relates to a cleaning, disinfection and drying system comprising an isolator system for preparing accessory parts and/or items for washing in general in pharmaceutical production.

DE 3608776 A1 discloses a box-shaped cleaning appliance which has an opening on a side surface, through which a gloved hand holding the part to be cleaned can reach into the interior of the container, wherein objects to be cleaned can be cleaned in the cleaning appliance with the aid of a spray device without infection carriers being able to pass onto the user's skin or in an uncontrolled manner into the environment. However, an arrangement of this type is awkward to use in the event of a multiplicity of objects to be cleaned and does not have any devices for protecting against the escape of infection carriers into the environment.

U.S. Pat. No. 4,354,514 discloses an apparatus for tubular or balloon-shaped objects, the apparatus having a cleaning and drying chamber with an incoming air filter for cleaning the ambient air and an outgoing air fan. The objects to be cleaned are pulled onto perforated tubes which can be acted upon with pressurized cleaning agent and drying air for the objects to be cleaned. By this means, both internal and external cleaning of the objects to be cleaned are possible. Possibilities for manual handling and of the cleaning or processing operation are not provided.

The invention is based on the object of providing a cleaning, disinfection and drying system of the type mentioned at the beginning which can be used for all clean room classes used in pharmaceutical production or medical technology.

### SUMMARY OF THE INVENTION

In the case of the cleaning, disinfection and drying system according to the invention, the washing compartment is designed as an isolator system and has carriers for items for washing, incoming air and outgoing air guide devices provided with filters, a glove carrier, which is arranged in a wall of the washing chamber, for gloves extending into the washing chamber for manipulating the item for washing located in the washing chamber, wherein the incoming air and outgoing air guide devices are designed for maintaining a differential pressure between the washing chamber and a work area in which the system is arranged.

Separate feed and drainage devices, which are provided with filters, for washing liquids and drying air can be connected to the washing chamber.

The glove carrier can be part of a front window for observing the interior of the washing compartment.

The lateral axis opening which is closable by a door can have devices for connecting to material locks for the loading and unloading of the washing compartment.

The material locks can have ventilation and venting devices which are separate here from the washing compartment.

In the system according to the invention, personal protection is paramount, this being achieved by interaction between the cleaning system and isolator system, i.e. cleaning and isolator function in a single washing chamber.

It is the aim to separate the operator reliably and consistently from the product or from the production thereof in a closed system. In isolators where, for example, cytostatic drugs are produced, a permanent negative pressure prevails.

### BRIEF DESCRIPTION OF THE DRAWINGS

The invention will be explained in more detail below with reference to an exemplary embodiment which is illustrated in the drawings.

In the drawing:

FIG. 1 shows a schematic partial view of a preferred embodiment of the system according to the invention;

FIG. 2 shows a partially broken-away view of the upper side of an embodiment of the washing chamber 2; and

FIG. 3 shows a view of the upper side of the washing chamber, on which an adjustable nozzle holder is arranged.

### DETAILED DESCRIPTION OF THE PREFERRED EMBODIMENTS

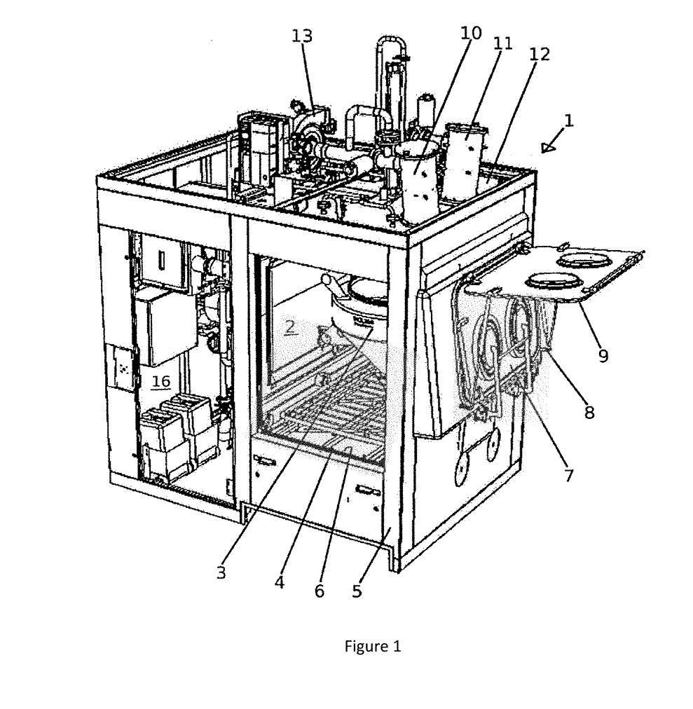

FIG. 1 shows a schematic view of the cleaning, disinfection and drying system 1. The system 1 has a washing chamber 2 which is preferably produced from stainless steel and does not have any dead space, and therefore can be readily cleaned. A support grate 4 on which an item for washing contained in an initially hermetically sealed container 3, only illustrated schematically, can be deposited via a loading system, not illustrated, is arranged in the washing chamber 2.

The loading system is connectable to a lateral access opening 16 of the washing chamber 2, wherein a material lock can be provided between the washing chamber 2 and the loading system. The connection between the washing chamber 2 and the loading system and optionally the material lock can be sealed by suitable hermetic seals, wherein a material lock has a separate ventilation and venting system.

On the front side, the washing chamber 2 has a glove carrier 7 for gloves extending into the washing chamber for manipulation of the item for washing located in the washing chamber. The glove carrier 7 can be formed by a glass panel which bears frames 8 for the fastening of the open end of respective gloves. The glove carrier 7, the frame 8 and the outer circumferences of the gloves themselves are hermetically sealed from one another. When the system (1) is not in use, the glove carrier 7 can be covered by a covering flap 9.

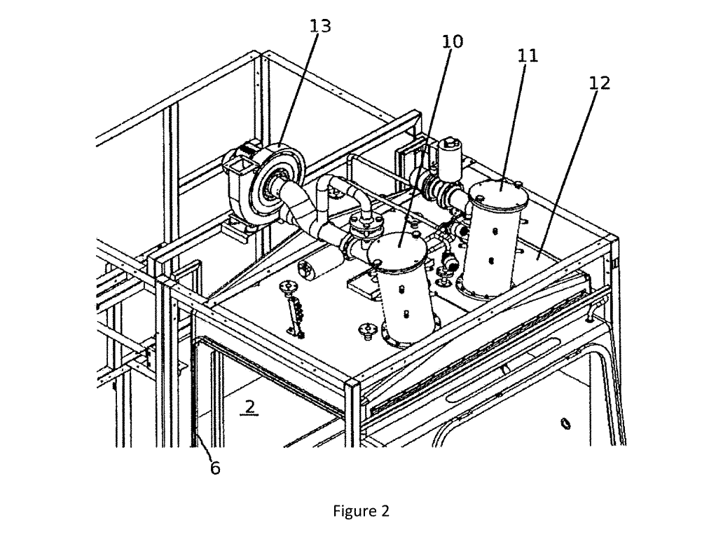

Filter stubs 10, 11 for the ventilation and venting of the washing chamber 2 are arranged on the upper side 12 of the washing chamber 2, as can be seen in particular from FIG. 2. Of the two filter stubs 10, 11, one is connected via a connecting line to the ventilator, while the other can be connected via a separate connecting line to the external air. Throttle valves which are controllable via control devices in order to obtain a desired positive or negative pressure in the washing chamber 2 can be arranged in both connecting lines.

Furthermore, a sealing arrangement 16 for a nozzle holder 14 which is movable both axially and also pivotably therein is arranged on the upper side 12 of the washing chamber 2. Said nozzle holder 14 is connected by a connecting line 15 to the washing agent and drying air supply of the washing chamber and, by manual or mechanical control, a jet can be directed onto otherwise difficult to reach regions of the item for washing and/or of the container initially receiving said item for washing.

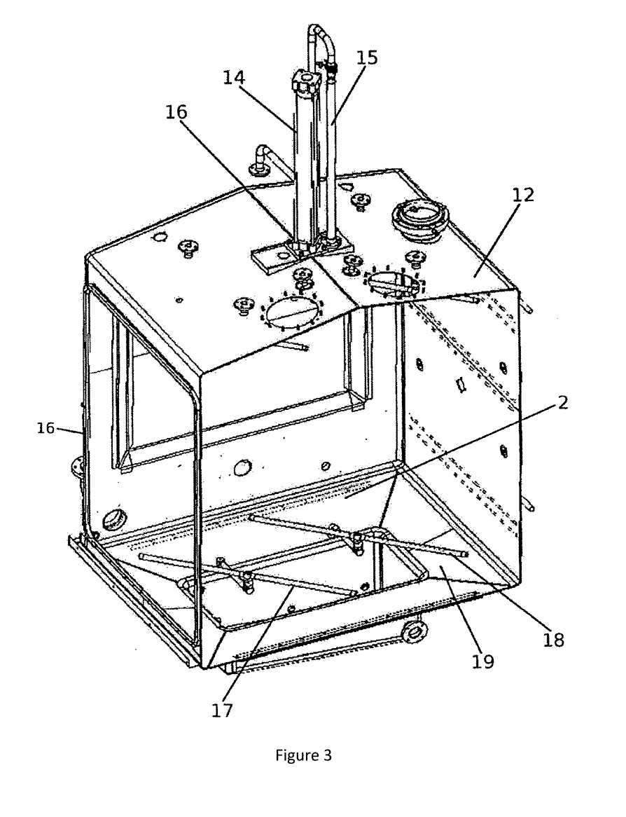

As can furthermore be seen from FIG. 3, rotatable washing arms 17, 18 with nozzles directed onto the item for washing, which is placed in the support grate 4, are arranged in the region of the bottom 19 of the washing chamber 2. Identical or similar washing arms can be arranged below the upper side 12 of the washing chamber 2 or else on the side surfaces thereof.

The lateral opening, denoted by 6 in FIGS. 1 to 3, of the washing chamber 2 is hermetically tightly closable preferably by means of a sliding door.

The washing chamber 2 is arranged in a support framework 5 which, in addition to the washing chamber 2, bears the supply devices, which are required for operation of the latter, in a further chamber 6.

The operation of the system may take place in the manner described below, but this merely constitutes an example:

The fully automatic sliding door in front of the lateral opening of the washing chamber is opened, whereupon the loading system, on which the item for washing and which is to be cleaned is located, is positioned in the washing compartment of the machine, wherein said positioning optionally takes place via a material lock in front of the lateral opening.

The contaminated item for washing is arranged in a hermetically sealed container, and therefore a, for example, highly potent contamination cannot come into contact with the operator.

If the loading operation has ended, the automatic sliding door on the lateral access opening is closed again, and the door seal assigned thereto is charged with compressed air. The entire system is therefore hermetically sealed off.

The operator can then remove the item for washing and which is to be cleaned via the gloves located on the front side and can place same into the necessary cleaning positions.

The cleaning, decontamination and drying operation can then be started.

After the decontamination cycles are ended, for example, the sliding door arranged on the lateral access opening can be opened for setting up the item for washing, or the item for washing can alternatively, however, be assembled outside the washing compartment.

The unloading operation corresponds to the loading operation as described previously. The above-described system 1 or the washing chamber 2 thereof, as already indicated, is equipped with filter technology, which is controllable by electronic control, for ambient air, incoming air and outgoing air, can be equipped with connections for a particle and microbial count, monitors air velocity and differential pressure for the filters and work area, has a front window with a glove port and also material locks for the loading and unloading of the isolator, which is formed by the washing chamber, with separate ventilator technology.

This results in consistent barrier technology for an automated, validatable decontamination system which permits rapid and highly efficient decontamination cycles and meets all product and personal protection requirements in the processing of highly potent products.

1. A cleaning, disinfection and drying system for preparing at least one of accessory parts and items for washing in general comprising a washing chamber that includes an access door and in which supply devices for washing liquids and drying air are arranged on spray nozzles and washing arms with spray nozzles, wherein the washing chamber comprises an isolator system and has carriers for items for washing, incoming air and outgoing air guide devices each including first filters, and a glove carrier arranged in a wall of the washing chamber, for gloves extending into the washing chamber for manipulation of the item for washing located in the washing chamber, and wherein the incoming air and outgoing air guide devices are configured to maintain a differential pressure between the washing chamber and a work area in which the system is arranged.

2. The system as claimed in claim 1, wherein separate feed and drainage devices for washing liquids and drying air are connected to the washing chamber.

3. The system as claimed in claim 1, wherein the glove carrier is part of a front window for observing the interior of the washing chamber.

4. The system as claimed in claim 1, wherein a lateral access opening is closable by the access door and includes connecting devices for material locks for the loading and unloading of the washing chamber.

5. The system as claimed in claim 4, wherein the material locks include first ventilation and venting devices which are separate from second ventilation and venting devices of the washing chamber.

6. The system as claimed in claim 1, wherein a sealing arrangement is arranged on an upper side of the washing chamber for a nozzle holder which is movable both axially and also pivotably in the washing chamber, the nozzle holder connected by a connecting line to the washing agent and drying air supply of the washing chamber and being configured, by manual or mechanical control, to direct a jet onto otherwise difficult to reach regions of at least one of the item for washing and a container initially receiving the item for washing.

7. The systems as claimed in claim 2, wherein the feed and drainage devices each include second filters.
